(19) United States
(12) Patent Application Publication
(10) Pub. No.: US 2017/0018129 A1
(43) Pub. Date: Jan. 19, 2017

(54) VEHICLE ENTRY KEYPAD WITH BATTERY CHARGE INDICATOR

(71) Applicant: FORD GLOBAL TECHNOLOGIES, LLC, Dearborn, MI (US)

(72) Inventor: Annette Lynn HUEBNER, White Lake, MI (US)

(21) Appl. No.: 15/209,358

(22) Filed: Jul. 13, 2016

(30) Foreign Application Priority Data
Jul. 15, 2015 (GB) 1512364.9

(51) Int. Cl. G07C 9/00; B60L 11/18; H02J 7/00

(52) U.S. Cl. CPC G07C 9/00142; H02J 7/0047; B60L 11/1861; H02J 2007/005; H02J 2007/0049

(57) ABSTRACT

A keypad mounted on the exterior of an electric vehicle, for example on the B-pillar, and is used to enter a code to enable unlocking and entry into the vehicle. The keypad is further operative to provide an indication of the state-of-charge of the battery of the vehicle. The keypad is made up of a series of active (for example, touch-sensitive) regions which illuminate when touched to enter the code. Each active region may illuminate selectively and individually to represent a predetermined percentage of battery charge, so that the total number of active regions illuminated corresponds to the state-of-charge of the battery.

### CROSS-REFERENCE TO RELATED APPLICATIONS

This application claims foreign priority benefits under 35 U.S.C. §119(a)-(d) to GB 1512364.9 filed Jul. 15, 2015, which is hereby incorporated by reference in its entirety.

### TECHNICAL FIELD

This invention relates to improvements in or relating to electric vehicles and, in particular, to entry keypads for these vehicles.

### BACKGROUND

Keyless entry to vehicles, in particular, motor vehicles is known. There are various different types of keyless entry including the use of a keypad on the exterior of the vehicle.

U.S. Pat. No. 8,994,495 discloses a keypad that is integral with a window of a vehicle. The keypad indicia are formed using a ultra-violet (UV) fluorescent dye that is nearly invisible to the human eye until exposed to UV light. A UV light emitting device is configured to illuminate the indicia in use making them visible to the user.

In an electric vehicle, the state-of-charge of the battery is clearly critical to the operation of the vehicle. Typically information about the state-of-charge has been displayed either on the dashboard in a similar manner to the familiar fuel gauge in a diesel or gasoline fueled vehicle or in the vicinity of the charging socket. For examples, JP3252035 shows a series of indicator lamps mounted adjacent the socket in the power supply section. These systems provide information to the user when charging and driving the vehicle respectively.

### SUMMARY

According to the present invention a keypad is provided on an exterior of an electric vehicle, the keypad being configured and operative to receive an input to enable access to the vehicle and to provide an indication of the state-of-charge of the battery of the vehicle.

The provision of information relating to the state-of-charge of the vehicle at the point of entry to the vehicle is advantageous when it is conveniently combined with the entry keypad. This allows the user to confirm the state-of-charge of the battery before entering the vehicle and embarking on a journey. The provision of the charge indicator with the vehicle entry keypad also saves time for the user who might otherwise have to access the vehicle charge point in order to verify the state-of-charge of the battery prior to commencing a journey.

The location of the keypad is chosen to optimize the experience of the user in terms of convenience and ease of use. In one embodiment, the keypad may be provided on a window of the vehicle. This is has additional advantage that the display may also be visible from inside the vehicle. Alternatively, the keypad may be provided on a trim panel of the vehicle, in particular, the B-pillar.

The keypad is configured to provide an indication of the state-of-charge of the battery of the vehicle. The indication of the state-of-charge of the battery of the vehicle may be provided using the access code entry region. This is the most space-efficient configuration in that the access code entry region is dual-purpose. In one example, each pair of indicia is provided within an active, rectangular region and the rectangular regions may be arranged substantially vertically above one another in a column. This columnar arrangement of rectangular regions is similar to a familiar battery charge indicator as provided on many commonly-encountered consumer electronic devices and it is therefore intuitive to the user to see the number of rectangular regions illuminated to correspond to the state-of-charge of the battery. For example, if all of the rectangular regions are illuminated, the battery is substantially fully charged. Each rectangular region may be configured to represent a predetermined percentage of battery charge so that the number of regions illuminated corresponds to the level of charge of the battery. For example, if there are five rectangular regions and each is configured to represent 20% charge and therefore if only one is illuminated, the charge level is 20% or less, if two are illuminated, the charge level is between 21-40%, if three are illuminated, the charge level is between 41-60% and if four are illuminated the charge level is between 61-80%.

In an alternative example, the indication of the state-of-charge of the battery of the vehicle may be provided adjacent the access code entry region. This configuration enables the state-of-charge of the battery to be provided simultaneously with the keypad indicia for entry to the vehicle.

The keypad may be further configured to provide an indication that the battery is being charged. This indication may be a static image or it may have some level of animation. For example, the rectangles may be configured to illuminate sequentially so that first the lowest one is illuminated, then the lower two, then three, then four, then finally all five are illuminated. Following this the illumination may be briefly removed before starting the sequence again. Each configuration may be held for 0.1 s, 0.5 s or 1 s, thus providing an animation indicative of the battery being charged.

The keypad may have an access code entry region that comprises a light-reactive substance that is configured to transition between being substantially invisible to the human eye and being visible when light of a specified waveband is incident thereon. The keypad may further comprise a light emitting device configured for outputting light of the specified waveband. The specified waveband may be UV light.

The access code entry region may be touch-sensitive to receive the input to enable access to the vehicle.

The access code entry region may comprise a plurality of indicia which may be the numbers 0-9, a selection of letters or shapes, or any other combination of symbols which will be easily memorable for the user. The indicia may be arranged in pairs. The pairs of indicia may be arranged substantially vertically above one another. By “substantially vertically” it should be understood that the pairs of indicia appear one above the other in a columnar configuration that extends further in the vertical extent than the horizontal direction. For example, if the indicia are provided on a section of B-pillar trim that extends at 10°, 20° or even 30° to the vertical, then this is still “substantially vertically” aligned.

The keypad may further comprise a data processor and a data storage device and wherein the keypad may be further configured to compare an input with a predefined code stored in the data storage device and, where the input and predefined code match, to enable access to the vehicle.

The invention will now be further and more particularly described, by way of example only, and with reference to the accompanying drawings, in which:

### BRIEF DESCRIPTION OF THE DRAWINGS

FIG. 1 shows a vehicle equipped with a keypad according to an example of the present invention, before the keypad is active;

FIG. 2 shows the keypad active and configured to enable access to the vehicle;

FIG. 3 shows the keypad in use for vehicle entry;

FIG. 4 shows the keypad in use as a charge status indicator;

FIG. 5 shows the keypad in use as a charge status indicator when the vehicle is charging;

FIG. 6 shows the keypad providing an indication of a fault; and

FIG. 7 shows a further example of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

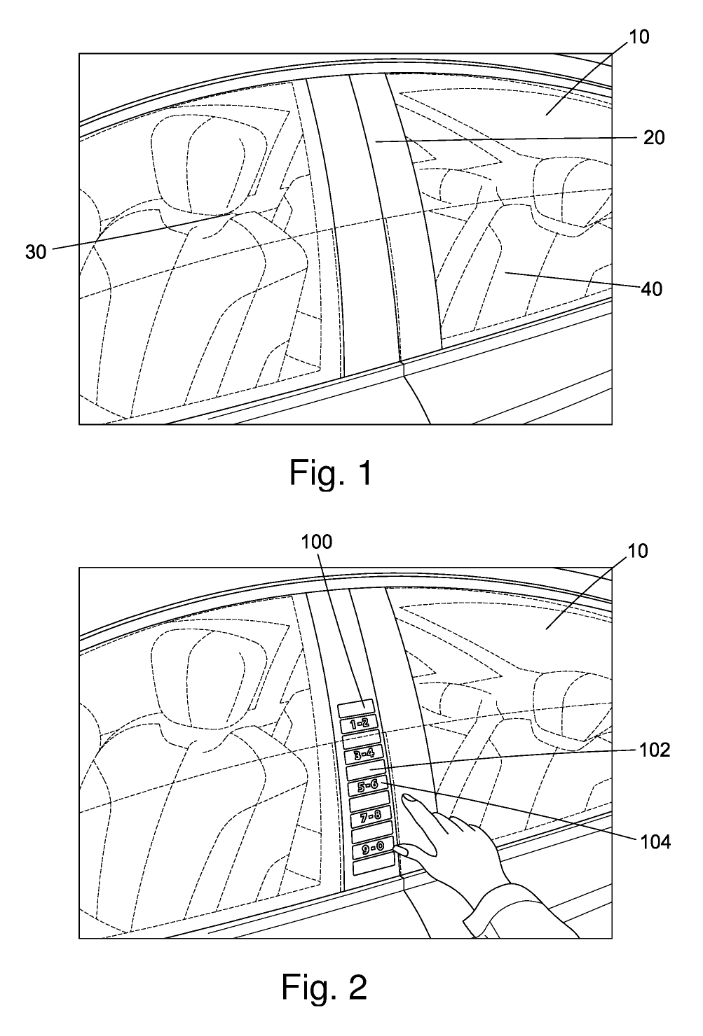

FIG. 1 shows, schematically, part of the side of a vehicle 10 including a B-pillar 20 between a front window 30 and a rear window 40. This is how the vehicle appears when the keypad of the present invention is not active. The keypad is not visible.

FIG. 2 shows the keypad 100 of the present invention when it is configured to enable access to the vehicle 10. The keypad 100 includes a number of active regions 102. Some of the active regions have indicia 104 and some are blank. Alternating active regions 102 are provided with indicia 104 in the form of pairs of numbers, 1-2, 3-4, 5-6, 7-8, 9-0. When the keypad 100 is being used for vehicle entry a light source (not shown) illuminates the indicia 104 so that the user can interact with the keypad to gain access to the vehicle.

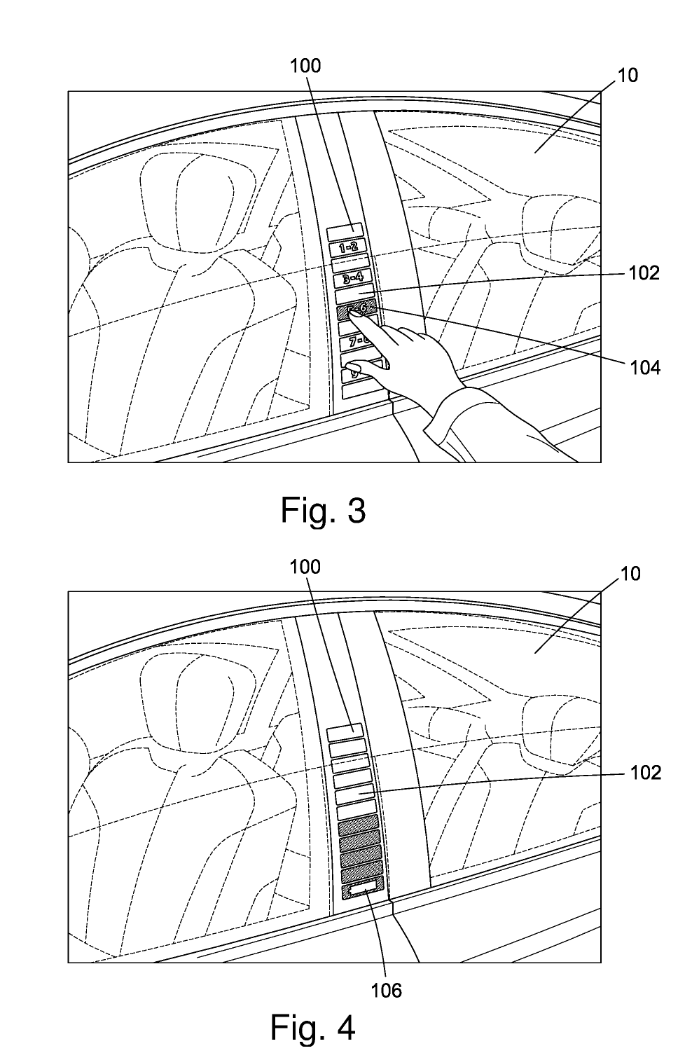

FIG. 3 shows the keypad 100 in use for vehicle entry. The input from the user is captured by the keypad using a touch-sensitive layer in the keypad (not shown) in order to interpret the user's input. When the user touches one of the indicia 104, substantially the entirety of the relevant active region 102 is illuminated in order to provide feedback to the user that the touch has been registered by the keypad 100. Whilst the active region 102 as a whole is illuminated, the illumination of the indicia 104 is changed so that there is still a visible contrast between the indicia and the remaining part of the active region 102.

FIG. 4 shows the keypad 100 in use as a charge status indicator. Each active region 102 corresponds to a charge level of 10%. Therefore the display currently indicates that there is 40% charge in the battery as the lower four active regions are illuminated, while the top six active regions remain unilluminated. The lowest active region shows a representation 106 of a battery.

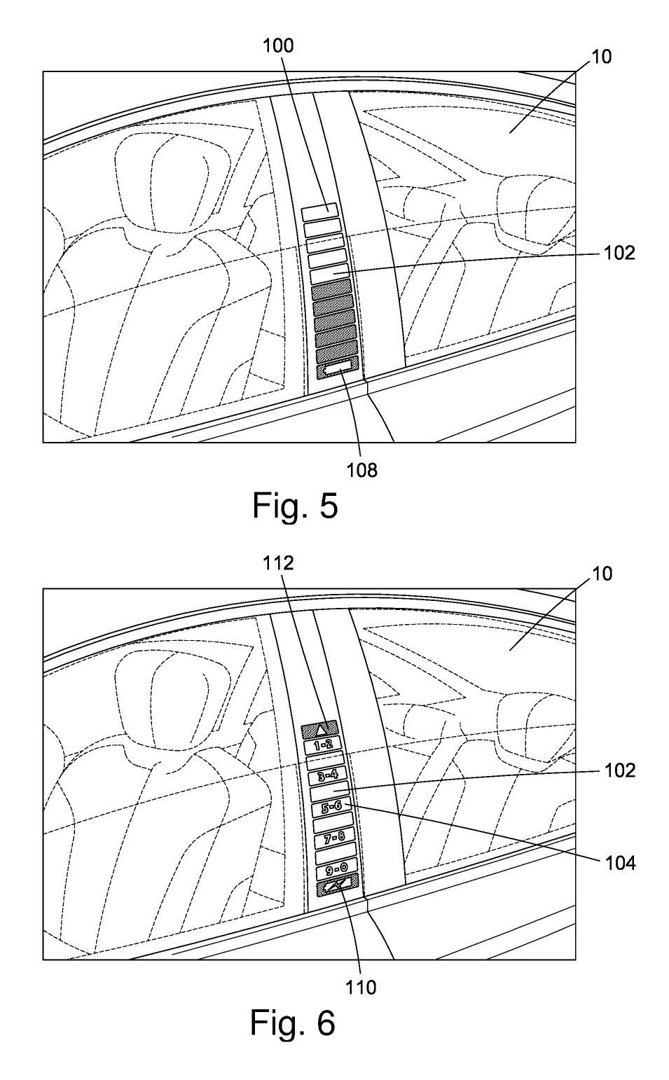

FIG. 5 shows a keypad 100 in use as a charge status indicator when the vehicle is charging. The image shows a representation 108 of a battery being charged. The number of regions illuminated changes from 1 incrementally up to ten and then drops back to zero. This sequence continues whenever the keypad 100 is activated throughout the charging of the battery.

FIG. 6 shows a keypad 100 providing an indication of a fault, together with the indicia 104 for use in vehicle entry. The fault indication comprises a battery icon 110 together with a warning triangle 112 in the uppermost active region 102. These are provided alongside the indicia 104 for use in vehicle entry.

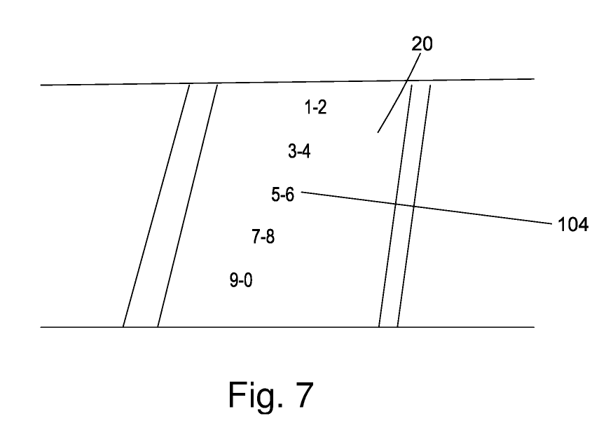

FIG. 7 shows a further example of a keypad 100. This keypad 100 is provided on a B-pillar 20 of a vehicle 10. In this example the B-pillar is not exactly vertical, and therefore the indicia 104 are somewhat offset horizontally with respect to one another, with 1-2 being further right than 3-4 etc. However, it will be apparent that these indicia 104 are substantially vertical and the related active regions will still form a columnar representation of the charge status of the battery, even though they are not exactly vertically aligned.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A keypad on an exterior of an electric vehicle comprising:
a plurality of touch-sensitive regions operative to enable access to the vehicle; wherein
the regions are further operative to selectively illuminate in a manner indicating a state-of-charge of a battery of the vehicle, a relatively lower state-or charge indicated by illumination of a relatively smaller number of the regions and a relatively higher state-of-charge indicated by illumination of a relatively larger number of the regions.

2. The keypad of claim 1, wherein the keypad is mounted on a B-pillar of the vehicle.

3. The keypad of claim 1, wherein each of the touch-sensitive regions is rectangular and includes indicia.

4. The keypad of claim 1, wherein the regions are arranged with respect to one another to form a vertical column.

5. The keypad of claim 1, wherein all of the regions are illuminated when the battery is fully charged.

6. The keypad of claim 1, wherein there are five regions, illumination of each of the regions representing a 20% charge of the battery.

7. The keypad of claim 1, wherein the keypad is further configured to indicate that the battery is being charged.

8. The keypad of claim 7, wherein when the battery is being charged, the regions illuminate in sequential and repeating pattern.

9. An entry keypad on an exterior of an electric vehicle comprising:
a plurality of active regions operative to receive an input by a user to enter a code sequence enabling access to the vehicle; wherein
the active regions are further operative to provide a visual indication of a state-of-charge of a vehicle battery.

10. The keypad of claim 9, wherein the keypad is mounted on a B-pillar of the vehicle.

11. The keypad of claim 9, wherein the active regions are touch-sensitive.

12. The keypad of claim 9, wherein the active regions illuminate to provide the visual indication of the state-of-charge.

13. The keypad of claim 12, wherein each active region represents a predetermined percentage of battery charge, and a number of active regions illuminated corresponds to the state-of-charge of the battery.

14. The keypad of claim 9, wherein each of the active regions is rectangular and includes indicia representing elements of the code sequence.

15. The keypad of claim 9, wherein the active regions are arranged with respect to one another to form a substantially vertical column.

16. The keypad of claim 9, wherein all of the active regions are illuminated when the battery is fully charged.

17. The keypad of claim 9, wherein there are five active regions, illumination of each of the active regions representing a 20% charge of the battery.

18. The keypad of claim 9, wherein the keypad is further configured to indicate that the battery is being charged.

19. The keypad of claim 18, wherein when the battery is being charged, the active regions illuminate in a sequential and repeating pattern.

20. A keypad mounted on an exterior of a B-pillar of an electric vehicle comprising:
a plurality of touch-sensitive regions arranged to form a column on the B-pillar, the regions operative by a user to input a code sequence enabling access to the vehicle; wherein
the regions are illuminatable to indicate a state-of-charge of a battery of the vehicle, each region being selectively and individually illuminatable to represent a predetermined percentage of battery charge, and a number of active regions illuminated corresponding to the state-of-charge of the battery.
